(19) United States
(12) Patent Application Publication
(10) Pub. No.: US 2023/0127905 A1
(43) Pub. Date: Apr. 27, 2023

(54) CABLE WITH A TACTILE TWIST INDICATOR AND METHOD FOR TORSION-FREE LAYING OF SUCH A CABLE

(71) Applicant: Kromberg & Schubert GmbH Cable & Wire, Rhede (DE)

(72) Inventors: Martin GREINER, Hemmingen (DE); Anne BREMER, Rhede (DE)

(21) Appl. No.: 17/969,084

(22) Filed: Oct. 19, 2022

(30) Foreign Application Priority Data
Oct. 22, 2021 (DE) 102021127570.9

(51) Int. Cl. G02B 6/44; H01B 7/36

(52) U.S. Cl. CPC G02B 6/4463; H01B 7/363; H02G 1/06

(57) ABSTRACT

A cable with a tactile twist indicator, wherein the cable has at least one core for signal transmission and a cable sheath surrounding the at least one core, wherein the cable has precisely one tactile twist indicator, which extends along a longitudinal direction of the cable over essentially the entire length of the cable sheath and which has a predetermined orientation relative to the at least one core over essentially the entire length of the cable sheath.

### RELATED APPLICATIONS

This application claims priority to German Patent Application No. 10 2021 127 570.9, filed Oct. 22, 2021, the entire contents of which are incorporated herein by reference in its entirety.

### FIELD

The invention relates to a cable with a tactile twist indicator and to a method for torsion-free laying of such a cable.

### BACKGROUND

A large number of cables for a wide variety of applications with different cross sections are known from the prior art. In some cases, however, it is necessary in the case of cables and in particular in the case of cables for sensors to be able to provide them as free as possible from torsion of the cable.

For example, in the case of cables with optical conductors, but also in the case of cables with electrically conductive cores, it is necessary for data transmission that is as error-free as possible and in some cases also for the acquisition of sensor data as error-free as possible that these are not laid in a distorted or twisted manner in the circumferential direction and more preferably also that they were not inadmissibly twisted before the laying in the circumferential direction.

For this purpose, the prior art provides colored marking lines along the cable, which can be used to visually check whether the cable is twisted along a predetermined laying route or along a predetermined cable path.

To put it simply, this color stripe, which runs in a straight line and exclusively in the longitudinal direction on the cable sheath, must not run around the cable or around the cable sheath in the circumferential direction during a visual check, otherwise the cable or the cores inside the cable will be twisted.

Both in the case of manual and automated assembly, the problem arises that the optical check is highly dependent on the lighting conditions in the region and on the cleanliness or contamination of the cable. If the cable is dirty or if it is comparatively dark, the optical marking, i.e. the color stripe, can often no longer be detected, or at least it can no longer be detected in a reliable way.

### BRIEF SUMMARY

The present disclosure provides a cable which can be laid in a simple manner without torsion or twisting.

This object is solved by the combination of features according to the main claims.

According to the disclosure, a cable with a twist indicator that can be felt or detected by touch is proposed, wherein the detection can be performed both manually, for example by a person, and also automatically, for example by means of a sensor. The cable has at least one core for signal transmission and a cable sheath surrounding the at least one core. Furthermore, the cable has exactly one tactile twist indicator, which can also be designated as a means for detecting a twist and/or torsion of the cable. The twist indicator extends along a longitudinal direction of the cable over an essentially entire length of the cable sheath and has a predetermined and in particular constant orientation or a predetermined path with respect to the at least one core over essentially the entire length of the cable sheath. If several cores are provided, the twist indicator has its predetermined orientation with respect to all cores or, conversely, all cores have a predetermined orientation with respect to the twist indicator.

The position of the cores can thus be deduced from the position or the path of the twist indicator over the length of the cable. If the twist indicator runs around the cable sheath in the circumferential direction, the core or cores are also twisted or distorted in the circumferential direction with respect to their desired position.

However, if the twist indicator runs in a straight line and without a portion or only a small portion in the circumferential direction, the core or cores are also untwisted and in their desired position.

In particular, the cable sheath can directly enclose the core or cores or a core sheath of the cores. Alternatively, the core or cores can also have an inner sheath and/or be sheathed by a shield, the cable sheath and the cores preferably being firmly connected and in particular connected in such a way that torsion of the cable sheath causes torsion of the cores.

The entire length of the cable sheath or at least over 90% of the length of the cable sheath can also be understood as being essentially the entire length of the cable sheath.

According to an advantageous development, the twist indicator is a projection protruding over the cable sheath in the radial direction of the cable sheath or a groove-like depression in the cable sheath.

Furthermore, the twist indicator can be a projection that protrudes from the cable sheath in the radial direction of the cable sheath and in which no core and in particular no core for signal transmission is arranged. In this case, the projection can also be referred to as a nose and can be free from cores. Correspondingly, the projection can be formed from solid material.

Preferably, the twist indicator and the cable sheath are formed in one piece and are formed integrally with each other.

According to an advantageous development, the twist indicator and the cable sheath can be formed or extruded together in a common extrusion process, in which the at least one core is overmolded with the cable sheath.

The twist indicator is preferably formed on just one side of the cable sheath in a cross section of the cable and circumferentially around the cable sheath at a predetermined position.

It is also advantageous if the twist indicator is formed at exactly the same position on each cross section of the cable in the circumferential direction around the cable sheath.

The circumferential direction is understood to be the circumferential direction around a cable axis or around the cable longitudinal direction, wherein the radial direction also relates to the cable axis or the cable longitudinal direction.

In addition to the tactile detectability, one variant provides that the twist indicator has a different color from the cable sheath, so that the tactile twist indicator can also be detected optically.

The core can be a core that conducts electrical or optical signals and, correspondingly, an electrical or optical conductor. In principle, each core can be formed from a single strand or from a large number of strands.

The cable can be a round cable or a flat cable.

In order to be able to recognize not only whether the cable was laid twisted, but also whether the cable was twisted or distorted unacceptably during laying or before or after laying, another advantageous variant provides that in or on the twist indicator and in particular over the substantially entire length of the cable sheath a force-sensitive and in particular mechanophoric element is arranged which is designed to change its optical appearance or its physical properties when a transverse force that is orthogonal to the longitudinal direction and exceeds a limit force and/or a torsional force acting in the circumferential direction is applied. For example, an element that is brittle in the circumferential direction can be provided, which breaks in the circumferential direction or becomes detached from the twist indicator when the cable is subject to torsion or twisting. Alternatively, however, the twist indicator can also have a mechanophoric color or a mechanophoric element, which changes color in the event of impermissible torsion or twisting, at which the limit force is exceeded. Alternatively, the element can also cover a colored region of the torsion indicator, which only becomes visible when the element is detached from the torsion indicator and thus indicates an inadmissibly strong torsion.

The at least one core can also have a round cross section. Alternatively, however, it can also be provided that the at least one core has a flat and, in particular, rectangular cross section. In this context, flat is understood to mean that the core in cross section has a greater extent in a first (transverse) direction than in a second (thickness) direction orthogonal to the first direction. Furthermore, it can preferably be provided that the cable has a large number of cores which have a flat and in particular rectangular cross section and which are stacked on top of one another in the cross section of the cable or directly abut one another in the radial direction relative to the central axis of the cable.

For example, the cable can have a flat and, in particular, rectangular core or a stack made of a plurality of flat and, in particular, rectangular cores, each of which can be referred to as a metallic layer.

The cores can be insulated individually and/or together in the circumferential direction of the cable. In particular, the cores can also be in direct contact with one another in an electrically conductive manner and can preferably be laminated to one another, so that together they form a conductor that is easily deformed in one direction.

Such a flat core can be formed from a multiplicity of individual strands or wires, for example also in the form of a wire mesh, or from a single sheet metal or sheet metal strip.

Furthermore, in an advantageous development, an end portion of the cable in the longitudinal direction of the cable can form a coding portion with the twist indicator as a coding element for a cable termination element. The cable termination element can be, for example, a plug or socket body the contact elements of which can be contacted with the cores. In this case, the cable is configured by the twist indicator so that it can only be joined to the cable termination element in a predetermined position. For example, the cable termination element has a receptacle for this purpose, the cross-sectional shape of which corresponds to the cable cross-section and in particular to the cross-section of the twist indicator. As a result, the cable termination element can only be slid onto the cable in a predetermined position. Since the cores of the cable have a predetermined orientation relative to the twist indicator, the cores therefore also have a predetermined orientation relative to the cable termination element and preferably to the contact elements of the cable termination element, so that the twist indicator also serves as an assembly aid.

A further aspect of the invention relates to a method for twist-free or torsion-free laying of a cable according to the invention along a predetermined cable or laying path. The cable is arranged along the predetermined cable path and is held in a predetermined orientation with the twist indicator during the positioning. Then, after having been arranged along the predetermined cable path, the cable is checked by optical and/or tactile detection of the twist indicator for impermissible twisting of the cable in the circumferential direction.

A laying aid can also be used for positioning the cable, which aid provides an opening corresponding to the cable cross-section and the twist indicator and thus forms a gauge. The twist indicator allows the cable to run through the laying aid or the opening only in the predetermined orientation, so that the cable can already be arranged along the cable path without being twisted during laying.

Even after laying, a comparatively simple tactile check is possible, which can be done both automatically and manually and is independent of the lighting and, for the most part, dirt.

In particular, the twist indicator also enables simplified, automated laying by means of a robot or a laying machine, since the cable can be guided mechanically by means of the twist indicator.

### BRIEF DESCRIPTION OF THE DRAWINGS

The features disclosed above can be combined in any way as long as such combination is technically feasible and said features do not contradict one another.

Other advantageous developments of the invention are characterized in the dependent claims and will be described in greater detail in the following, in conjunction with the description of the preferred embodiment of the invention, with reference to the figures. In the figures:

FIG. 1a, b each show a cable with a first variant of a twist indicator in cross section;

FIG. 2a, b each show a cable with a second variant of a twist indicator in cross section;

FIG. 3a, b each show a cable with a third variant of a twist indicator in cross section; and

FIG. 4 shows a cable in a top view.

### DETAILED DESCRIPTION

The figures show schematic examples. Same reference symbols in the figures denote same functional and/or structural features.

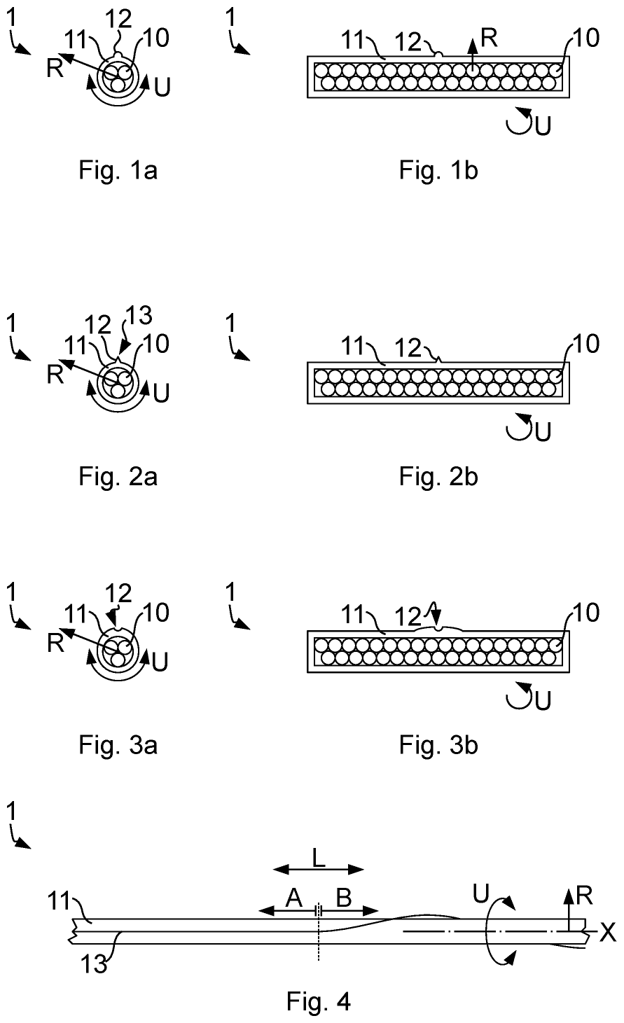

FIGS. 1 to 3 each show a cable 1 in cross section with a variant of a twist indicator 12, a round cable being shown in the respective FIG. 1a, 2a, 3a and a flat cable being shown in the respective FIG. 1b, 2b, 3b.

The cables 1 each have a plurality of cores 10, the numbers of cores 10 shown being purely exemplary. In addition, the cores 10 are sheathed in the circumferential direction U with the cable sheath 11, which can also lie completely against the outer surfaces of the cores 10.

In FIGS. 1a and 1b, a protruding twist indicator 12 is provided with a part-circular cross section, which can also be referred to as a nose and protrudes in the radial direction R over the cable sheath 11 and can therefore be detected by a sensor or a person, i.e. can be detected tactily.

Also in the case of a flat cable 1, as shown in FIGS. 1b, 2b and 3b, the radial direction R and the circumferential direction U relate to a respective central or longitudinal axis X of the cable 1.

In FIGS. 2a and 2b, the twist indicator 12 has a triangular cross section, wherein a tip 13 of the triangular twist indicator 12 forms an edge over the longitudinal direction of the cable, which can be easily detected optically and tactily.

As an alternative to the twist indicators 12 designed as projections of the variants according to FIGS. 1a to 2b, the twist indicator 12 can also be provided as a groove-like depression, as is shown in FIGS. 3a and 3b. The region of the cable sheath 11 immediately adjacent to the groove-like depression or adjacent to the twist indicator 12 is preferably thicker than adjacent regions of the cable sheath 11, so that the minimum thickness of the cable sheath 11 required for adequate insulation is not exceeded. Correspondingly, the twist indicator 12 forms a recess in relation to the surface of the cable sheath 11, which, however, can also be easily detected tactily. In addition, a twist indicator 12 designed as a depression is better protected against unintentional shearing off or detachment than a twist indicator 12 designed as a projection.

In the case of the flat cables according to FIGS. 1b, 2b and 3b, the twist indicator 12 is arranged in the middle of a long side of the essentially rectangular cable sheath 11, wherein the twist indicator 12 can alternatively also be arranged on a short side of the cable sheath 11 and also eccentrically.

FIG. 4 shows a cable 1 in a top view or a view from above, the cable 1 having as an example a twist indicator 12 according to the variant shown in FIG. 2a and having a first region A and a second region B along its longitudinal direction L. In simplified form, the twist indicator 12 is only represented by the path of its tip 13 or the edge formed by the tip 13.

In the first portion A, the tip 13 or the edge of the twist indicator 12 runs in a straight line and without torsion in the circumferential direction U. Since the twist indicator 12 has a predetermined orientation relative to the cores 10, the cores 10 within the cable sheath 11 are also not twisted or distorted and run in a straight line.

In the second portion B, the tip 13 or the edge of the twist indicator 12 runs in a twisted or rotated manner in the circumferential direction about a central axis X of the cable 1. Correspondingly, the cores 10 are also distorted or twisted within the cable sheath 11, which can be easily recognized from the path of the tip 13.

Depending on the nature of the cable 1 and the cores 10, the cable 1 or the cores 10 can then be brought into an untwisted/undistorted path using the twist indicator 12 or the entire cable 1 can be replaced.

The invention is not limited in its form to the preferred exemplary embodiment provided above. Rather, a number of variants is conceivable, which make use of the presented solution even with fundamentally different designs.

1. A cable with a tactile twist indicator,
wherein the cable has at least one core for signal transmission and a cable sheath surrounding the at least one core,
wherein the cable has precisely one tactile twist indicator, which extends along a longitudinal direction of the cable over essentially the entire length of the cable sheath and which has a predetermined orientation to the at least one core over essentially the entire length of the cable sheath.

2. The cable of claim 1, wherein the twist indicator is a projection protruding over the cable sheath or a groove-like depression in the cable sheath.

3. The cable of claim 1, wherein the twist indicator is a projection protruding over the cable sheath, in which no core and in particular no core for signal transmission is arranged.

4. The cable of claim 1, wherein the twist indicator and the cable sheath are formed as a single piece and are integral with each other.

5. The cable of claim 4, wherein the twist indicator and the cable sheath are formed in a common extrusion process, in which the at least one core is overmolded with the cable sheath.

6. The cable of claim 1, wherein the twist indicator is formed in a cross section of the cable on just one side of the cable sheath and in the circumferential direction around the cable sheath at a predetermined position.

7. The cable of claim 6, wherein the twist indicator is formed at exactly the same position at each cross-section of the cable in the circumferential direction around the cable sheath.

8. The cable of claim 1, wherein the twist indicator has a different color from the cable sheath, so that the tactile twist indicator can be detected optically.

9. The cable of claim 1, wherein the core is a core conducting electrical or optical signals.

10. The cable of claim 1, wherein the cable is a round cable or a flat cable.

11. The cable of claim 1, wherein a force-sensitive, mechanophoric, element is arranged in or on the twist indicator and in particular over the substantially entire length of the cable sheath, which element is designed to change its optical appearance or its physical properties when a transverse force and/or torsional force is applied which is orthogonal to the longitudinal direction and which exceeds a limit force.

12. The cable according to claim 1, wherein the at least one core has a round cross-section,
or wherein the at least one core has a flat and in particular rectangular cross-section,
or wherein a plurality of cores are provided, which have a flat and in particular rectangular cross-section and which are stacked on top of one another in the cross-section of the cable.

13. The cable of claim 1, wherein an end portion of the cable in the longitudinal direction of the cable forms a coding portion with the twist indicator as a coding element for a cable termination element, and wherein the cable is formed by the twist indicator, in such a way that it can be joined with the cable termination element only in a predetermined position.

14. A method for torsion-free laying of the cable of claim 1, along a predetermined cable path,
wherein the cable is arranged along the predetermined cable path and is held in a predetermined orientation with the twist indicator during the positioning, and
wherein the cable is checked for impermissible twisting of the cable in the circumferential direction after its positioning along the predetermined cable path, by optical and/or tactile detection of the twist indicator.
